(19) United States
(12) Patent Application Publication
(10) Pub. No.: US 2023/0290239 A1
(43) Pub. Date: Sep. 14, 2023

(54) System and Method for Residential Methane Detection

(71) Applicant: Safety Scan USA, Inc., Tempe, AZ (US)

(72) Inventor: Elias Nakhl Tobias, Palm Coast, FL (US)

(73) Assignee: Safety Scan USA, Inc., Tempe, AZ (US)

(21) Appl. No.: 18/090,406

(22) Filed: Dec. 28, 2022

Related U.S. Application Data
(60) Provisional application No. 63/295,074, filed on Dec. 30, 2021.

(51) Int. Cl. G08B 21/16; H04Q 9/00; G01M 3/04

(52) U.S. Cl. CPC G08B 21/16; H04Q 9/00; G01M 3/04

(57) ABSTRACT

A computer-implemented method of communicating and controlling real-time, continuous, dynamically updated, and geographically relevant information to a minimize or prevent a potentially hazardous gas leak utilizing a residential methane detection system to monitor a property, detect the gas, measure the level of the gas, and when the level of the gas is at or above about a predetermined level to trigger a localized or remote notification, alarm, or emergency service response while maintaining the option to automatically shut off the flow of gas with a compatible gas in response to a potential detected gas leak.

### CROSS-REFERENCE TO RELATED APPLICATIONS

This application claims priority to U.S. Provisional Ser. No. 63/295,074 entitled “System and Method for Residential Methane Detection,” filed on Dec. 30, 2021.

### BACKGROUND

### 1. Field of the Invention

The field of the present invention generally relates to a real-time methane detection system that provides measurement, monitoring, and alarm notification of a methane leak. This invention also generally relates to automatic shutoff of a compatible gas valve in response to methane at or above a pre-determined threshold such as an explosive level. Additionally, this invention generally relates to authentication, communication, notification, alarm, and other information between a methane detection device, a compatible gas valve located at a pre-determined geographical location, such as a home address, a user, optionally a gas utility, and optionally a compatible gas valve manufacturer.

### 2. Description of Related Art

Methane, a component of natural gas, is more efficient and cheaper than electricity for heating and cooking and is used in household appliances such as natural gas furnaces, space heaters, water heaters, and stoves. However, gas supply pipes and gas appliances have the potential to malfunction, leak, and send gas throughout the home having a variety of effects on those living within the home and on the home itself such as health effects, asphyxiation, and explosion hazard.

Natural gas leaks typically emit a rotten-egg smell throughout the house; however, a gas leak may be small and steady such that the rotten-egg smell is undetectable. Additionally, the rotten-egg smell can dissipate over time also making it undetectable or lead people to assume incorrectly that the problem has been resolved. Another sign of a gas leak is a hissing sound that may be coming from the damaged line or appliance that is causing the problem. Symptoms of natural gas poisoning include gastrointestinal problems, an increase in allergic reactions, fatigue, forgetfulness, high red and white blood cell counts, migraines, pain and discomfort.

Existing natural gas detectors, including methane detectors, are different than smoke or CO2 detectors and are generally installed by plugging into a wall outlet located close to the floor. Installation of the gas detector down low is ineffective as methane is lighter than air and rises. Existing gas detectors also use an ineffective chemical sensor that gives false positives in the presence of many household volatile organic chemicals (VOCs) such as cleaning products, hair products, hairspray, furniture polish, room disinfectant, deodorant, and fabric refresher. Any false positives may lead to consumers not trusting the gas detector or consumers ignoring alarms from the gas detector when there is an actual gas leak. Additionally, some gas detectors require calibration leading to decreased effectiveness of the gas detector if not calibrated or replacement leading to increased costs for a property owner to monitor for gas leaks.

However, the greatest risk, the risk of explosion to both the property owner and surrounding neighbors is increased when windows and doors are closed and there is no one home to smell the gas leak, hear an alarm from a gas detector, or take action to notify emergency personal or a gas utility.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY

The present invention provides among other things a residential methane detector (RMD) that when installed and powered on communicates with a user's mobile device for authentication, setup, and preferences and with a sever for authentication and monitoring such as by cellular, Wi-Fi, near-field, LoRa, Bluetooth, another communication protocol, or combination of communication protocols. Implementations of the present invention may provide for the server to communicate and establish a connection with a compatible gas valve by a pre-defined communication protocol then the server notifies a gas utility of the compatible gas valve and optionally notifies a gas valve manufacturer of the compatible gas valve. Particular aspects of the present invention may provide for the server to continuously monitor the health and state of the RMD such as by monitoring the constant time intervals of a live RMD by a network such as a cellular network. Particular aspects of the present invention may provide for the RMD and/or the server to optionally notify the user, gas utility, and/or gas valve manufacturer if the RMD, the compatible gas valve, or residential methane detection system goes offline (such as an RMD that is no longer live). Particular aspects of the present invention may provide for the practical application of the detection and real-time monitoring and communication of potential gas leaks brought about by computerized technology such as the internet-of-things (IoT) and automatic notifications both locally and remote from the methane gas detection hardware.

Implementations of the present invention may provide for the RMD to measure continuously for a methane leak and communicate real-time information related to the RMD and measured methane levels to the server and if the RMD or the server determines that a methane level is at about or above a pre-determined threshold, the RMD will alarm such as with a loud audio or spoken message. Particular aspects of the present invention may include if the RMD or the server determines that a methane level is at about or above a pre-determined threshold, the RMD and/or the server may notify the gas utility, user, and emergency services and optionally provide information related the urgency of the methane levels and location information such as a physical location, such as an address, where the gas leak was detected. Particular aspects of the present invention also provide for more than the detection of methane gas by integration of hardware capable of effective and stable methane detection system located near a potential gas leak with local and remote communication, monitoring, and alarm protocols including transmitting real-time gas detection data and automating emergency services.

Implementations of the present invention may include that if the RMD and/or the server determine that a methane level is at about or above a pre-determined threshold, the RMD, the user, the server, the gas utility, the compatible gas valve manufacture, or another third party may shut down the connected gas valve. Particular aspects of the present invention may provide for a holistic solution for mitigating real and severe hazards associated with methane gas by integration of monitoring hardware in an appropriately installed location, real-time local and remote communication about the status of the methane detection system, detection of a potential gas leak in the area, and automated responses related to a potential detected gas leak. Additionally, implementations of the present invention include reducing potential hazards from a gas leak by automating a compatible gas valve to autonomously shut off the flow of gas in response to a potential detected gas leak.

Implementations of a gas detection system may comprise a gas valve configured for remote actuation, a gas valve communication module configured to communicate with at least one of an authentication server and a monitoring server over a communication network, a gas detector comprising a gas sensor configured to detect a level of a gas that exceeds a predetermined threshold level, a gas detector power source, a gas detector user interface, and a gas detector communication module configured to communicate with the at least one of the authentication server and the monitoring server over the communication network in response to detection by the gas sensor of the predetermined threshold level of the gas being exceeded. The gas valve may be configured to be remotely actuated to a closed position in response to a signal received by the gas valve communication module from at least one of the authentication server and the monitoring server in response to a prior communication from the gas valve communication module that the predetermined threshold level of the gas is exceeded.

Particular aspects may comprise one or more of the following features. The gas valve may comprise at least one of a gas pipe shutoff, a solenoid, a servomotor, a check valve, a control valve, a hydraulic valve, a pneumatic valve, an electric valve, a thermal valve, a magnetic valve, a mechanical valve, a single valve, a single port valve, a multiple port valve, and a flow regulator valve. The communication network may comprise at least one of the following: a cellular network, a 3G cellular network, a 4G cellular network, a 5G cellular network, a LTE cellular network, a LTE-M cellular network, a low power wide area network cellular network (cellular LPWAN), a category M1 (CAT M1) cellular network, a narrowband IoT (NB-IoT) network, a category narrow band (CAT-NB) network, a wireless fidelity (Wi-Fi) network, a 2.4 GHz Wi-Fi network, a 5 GHz Wi-Fi network, a near-field communication protocol, a low-energy shortwave radio wave communication network, a small wave radio network, a long range low power radio (LoRa) network, LoRaWan network, a low power wide area network (LPWan) network, radiofrequency (RF) communication network, an intranet network connection, a remote network connection, a cloud network connection, a local area network (LAN) network connection, a wide area network (WAN) network connection, a personal area network (PAN), a mesh network, an infrared network, a Bluetooth network, a ZigBee network, a Z-wave network, a magnetic induction network, an optical transmission network, and an acoustic wave network. The authentication server may comprise at least one of a centralized access and authentication policy based server, a user authentication server, a password based authentication server, a multi-factor authentication server, a certificate based authentication server, a biometric authentication server, a facial authentication server, a fingerprint authentication server, a speaker authentication server, an eye scanner authentication server, a token based authentication server, a hardware authentication server, a software authentication server, a device authentication server, a QR code authentication server, a bar code authentication server, a hardware security module authentication server, a trusted platform module authentication server, a certificate authentication server, a distributed authentication server, a symmetric key authentication server, a server based authentication server, and a centralized authentication server method. The monitoring server may comprise at least one of a monitoring cloud server, a centralized monitoring server, and a dashboard server.

The gas detector user interface may be configured to provide a notification, wherein the notification comprises at least one of a notification interface, an audible user interface, an audible alarm, a message, an audible message, a visual user interface, a visual message, a notification light, a display panel, a warning, an alert, and an offline message. The gas valve may be configured to be actuated by at least one of a command proximal to the area where the potential gas leak was detected, a command remote to the area where the potential gas leak was detected, a server command, a gas detector command, a user command, a user's mobile device command, a gas utility command, a compatible gas valve manufacture command, and a third-party command. The gas may comprise at least one of a methane gas, a methane gas mixture containing additives, a butane, a propane, and a hydrocarbon gas mixture. The gas sensor may comprise at least one of a single gas sensor, multiple gas sensors, a mechanical sensor, a vibrational sensor, a tuning fork sensor, a chemical sensor, an infrared sensor, a non-dispersive infrared (NDIR) gas sensor, an optical sensor, a calorimetric sensor, a pyroelectric sensor, a pellistor sensor, a photoionization sensor, a semiconducting metal oxide sensor, an electrochemical sensor, a methane gas sensor, an uncalibrated gas sensor, a partially calibrated gas sensor, and a calibrated gas sensor. The gas detection system may be further configured to notify a user when the gas sensor detects that the level of gas exceeds the predetermined threshold level via at least one of a visual notification, an audible notification, an alert, a warning, a lower explosive level (LEL), a percentage level, a discrete level, a message, and a message to vacate.

Implementations of a method of gas detection may comprise detecting, by a gas sensor of a gas detector, a presence of a gas that exceeds a predetermined threshold level of the gas and sending, by a communication module of the gas detector and via a communication network, a communication to at least one of an authentication server and a monitoring server in response to detecting the presence of the gas that exceeds the predetermined threshold level of the gas, the gas detector further comprising a gas detector power source and a gas detector user interface. The method may further comprise receiving, by a communication module of a gas valve that is configured for remote actuation, a signal from the at least one of the authentication server and the monitoring server via the communication network in response to the prior communication to the at least one of the authentication server and the monitoring server and remotely actuating the gas valve to a closed position in response to the signal received by the communication module of the gas detector.

Particular aspects may comprise one or more of the following features. The gas valve may comprise at least one of a gas pipe shutoff, a solenoid, a servomotor, a check valve, a control valve, a hydraulic valve, a pneumatic valve, an electric valve, a thermal valve, a magnetic valve, a mechanical valve, a single valve, a single port valve, a multiple port valve, and a flow regulator valve. The communication network may comprise at least one of the following: a cellular network, a 3G cellular network, a 4G cellular network, a 5G cellular network, a LTE cellular network, a LTE-M cellular network, a low power wide area network cellular network (cellular LPWAN), a category M1 (CAT M1) cellular network, a narrowband IoT (NB-IoT) network, a category narrow band (CAT-NB) network, a wireless fidelity (Wi-Fi) network, a 2.4 GHz Wi-Fi network, a 5 GHz Wi-Fi network, a near-field communication protocol, a low-energy shortwave radio wave communication network, a small wave radio network, a long range low power radio (LoRa) network, LoRaWan network, a low power wide area network (LPWan) network, radiofrequency (RF) communication network, an intranet network connection, a remote network connection, a cloud network connection, a local area network (LAN) network connection, a wide area network (WAN) network connection, a personal area network (PAN), a mesh network, an infrared network, a Bluetooth network, a ZigBee network, a Z-wave network, a magnetic induction network, an optical transmission network, and an acoustic wave network. The authentication server may comprise at least one of a centralized access and authentication policy based server, a user authentication server, a password based authentication server, a multi-factor authentication server, a certificate based authentication server, a biometric authentication server, a facial authentication server, a fingerprint authentication server, a speaker authentication server, an eye scanner authentication server, a token based authentication server, a hardware authentication server, a software authentication server, a device authentication server, a QR code authentication server, a bar code authentication server, a hardware security module authentication server, a trusted platform module authentication server, a certificate authentication server, a distributed authentication server, a symmetric key authentication server, a server based authentication server, and a centralized authentication server method. The monitoring server may comprise at least one of a monitoring cloud server, a centralized monitoring server, and a dashboard server.

The method may further comprise providing, by the gas detector user interface, a notification, wherein the notification comprises at least one of a notification interface, an audible user interface, an audible alarm, a message, an audible message, a visual user interface, a visual message, a notification light, a display panel, a warning, an alert, and an offline message. The gas valve may be configured to be actuated by at least one of a command proximal to the area where the potential gas leak was detected, a command remote to the area where the potential gas leak was detected, a server command, a gas detector command, a user command, a user's mobile device command, a gas utility command, a compatible gas valve manufacture command, and a third-party command. The gas may comprise at least one of a methane gas, a methane gas mixture containing additives, a butane, a propane, and a hydrocarbon gas mixture. The gas sensor may comprise at least one of a single gas sensor, multiple gas sensors, a mechanical sensor, a vibrational sensor, a tuning fork sensor, a chemical senso, an infrared sensor, a non-dispersive infrared (NDIR) gas sensor, an optical sensor, a calorimetric sensor, a pyroelectric sensor, a pellistor sensor, a photoionization sensor, a semiconducting metal oxide sensor, an electrochemical sensor, a methane gas sensor, an uncalibrated gas sensor, a partially calibrated gas sensor, and a calibrated gas sensor.

The method may further comprise notifying a user when the gas sensor detects that the level of gas exceeds the predetermined threshold level via at least one of a visual notification, an audible notification, an alert, a warning, a lower explosive level (LEL), a percentage level, a discrete level, a message, and a message to vacate.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIGS. 1A-1C representatively illustrate a detailed process diagram of an embodiment of a methane detection system.

FIG. 2 representatively illustrates a general process diagram of an embodiment of a residential methane detection system.

FIG. 3 representatively depicts a block diagram of an embodiment a methane detection system.

FIG. 4 representatively depicts a detailed process diagram of an embodiment of a residential methane detection system.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

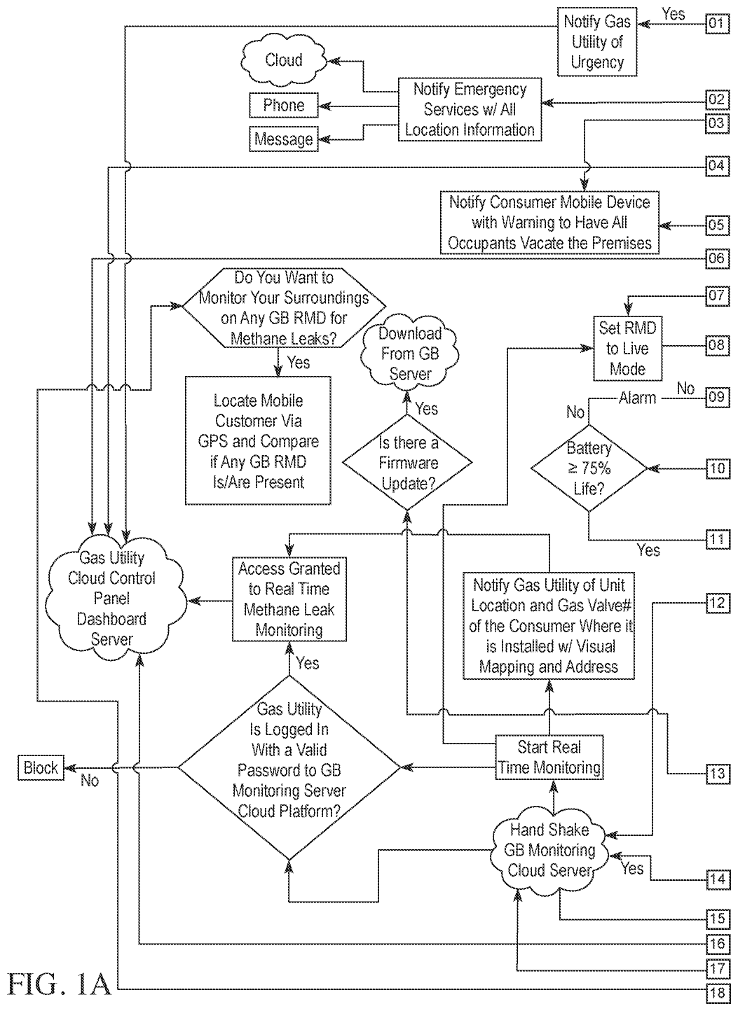

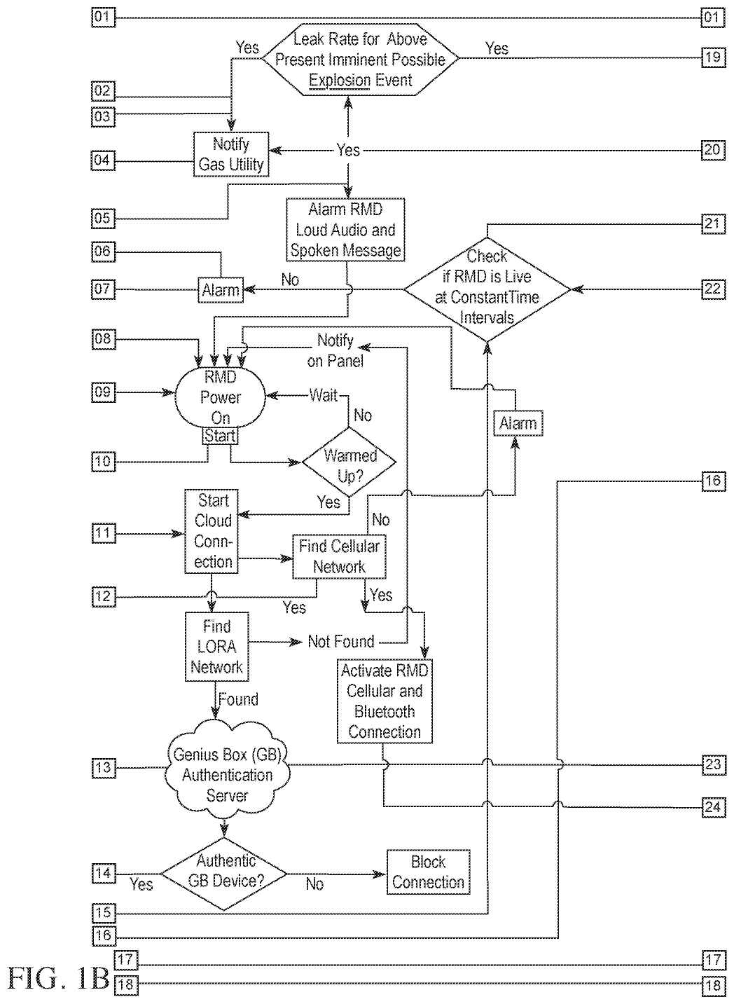

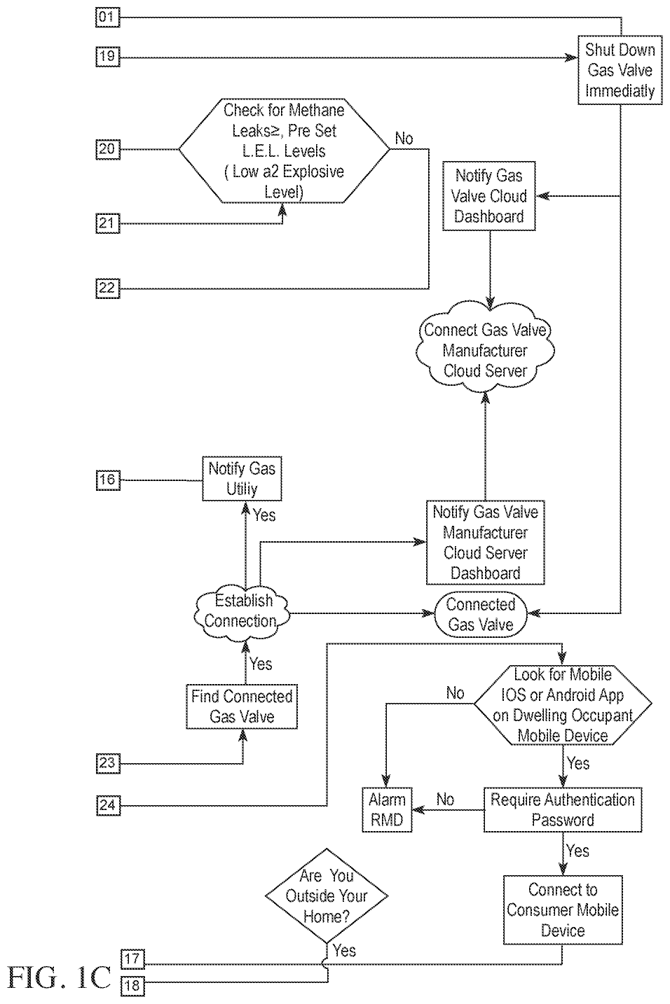

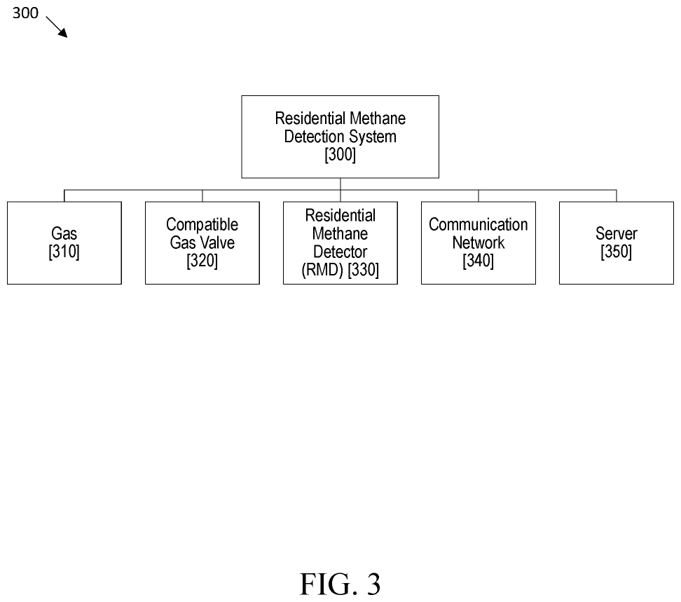

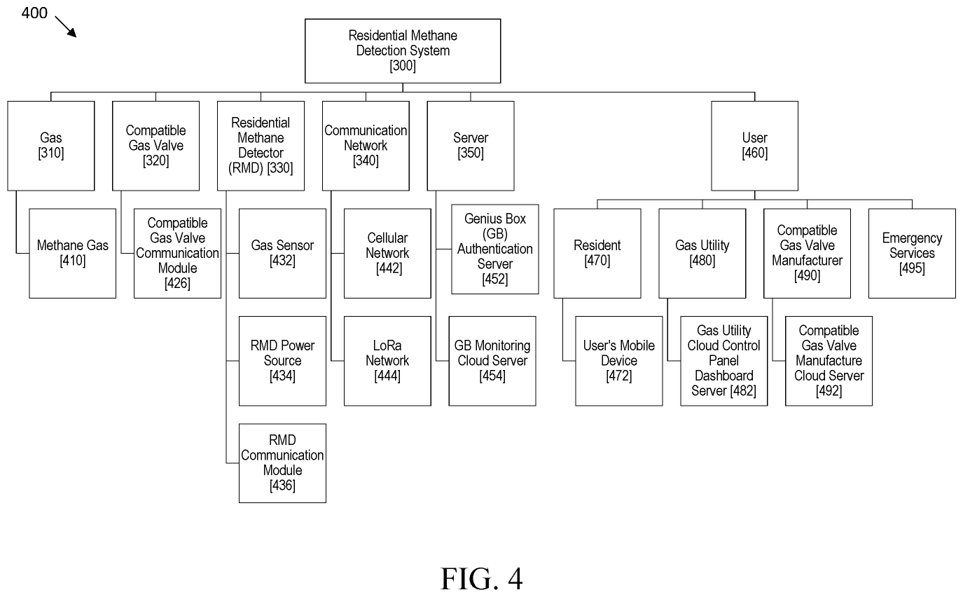

In one application, a residential methane detection system 300 may provide real-time, continuous, dynamically updated, and geographically relevant information about the presence of a gas 310. In one embodiment, the residential methane detection system 300 may comprise any suitable system for supplying a gas 310 and a compatible gas valve 320, a residential methane detector (RMD) 330. In one embodiment, the residential methane detection system 300 may comprise any suitable system for supplying a gas 310, a compatible gas valve 320, a residential methane detector (RMD) 330, and a communication network 340. In one embodiment, the residential methane detection system 300 may comprise any suitable system for supplying a gas 310, a compatible gas valve 320, a residential methane detector (RMD) 330, a communication network 340, and a server 350 as shown in FIG. 1A through FIG. 4.

In one embodiment, the residential methane detection system 300 may comprise any suitable system for detecting or measuring a gas 310, such as a methane gas 410, a compatible gas valve 320, such as a solenoid, a RMD 330, a communication network 340, such as a cellular network 442 and a long-range low power (LoRa) network 444, and a server 350 as shown in FIG. 1A through FIG. 4. In another embodiment, the residential methane detection system 300 may be optionally configured to communicate with a user 460, such as a resident 470, a user's mobile device 472, a gas utility 480, a compatible gas valve manufacturer 490, or an emergency service 495, such as a first responder emergency service, a fire emergency service, a medical emergency service, a police emergency service, a government emergency service; a federal emergency service, a county emergency service, a state emergency service, a city emergency service, a local emergency service, a municipal emergency service, an environmental protection service, a federal emergency management agency, a hazardous mitigation service, a private service, an alarm service, a military service as shown in FIG. 1A through FIG. 4. The residential methane detection system, may however, be configured in any suitable manner to measure, detect, monitor, notify, alarm, warn, or provide other information about the gas 310, such as the methane gas 410.

In one embodiment, the gas 310 may be a methane gas 410, a natural gas, a gas mixture containing methane gas, a methane gas mixture containing additives, a propane, a butane, or another hydrocarbon gas mixture. In another embodiment, the gas 310 may be configured to be supplied by a pipe, a storage tank, or a transportation container. In another embodiment, the gas 310 may be configured to be supplied as a compressed natural gas or a liquefied petroleum gas. In another embodiment, the gas 310 may be configured to be supplied, controlled, and monitored by the gas utility 480. In one embodiment, the gas utility 480 may comprise a gas utility server such as a gas utility cloud control panel dashboard server 482. The gas 310, may however, be configured in any suitable manner to provide fuel including fuel to a vehicle, a generator, a turbine, a natural gas furnace, a heating or cooling unit, a broiler, a space heater, a water heater, a range, an oven, a stove, and a clothes dryer.

In one embodiment, the compatible gas valve 320, may comprise a gas pipe shutoff. In another embodiment, the compatible gas valve 320 may be configured as a solenoid valve, a servomotor, a check valve, a control valve, a hydraulic valve, a pneumatic valve, an electric valve, a thermal valve, a magnetic valve, or a mechanical valve. In another embodiment, the compatible gas valve 320 may be configured as a single valve or more than a one port valve. In another embodiment, the compatible gas valve 320 may be configured to regulate or control the flow of the gas 310. In another embodiment, the compatible gas valve 320 may be configured to communicate and provide information about the flow of the gas 310 to the RMD 320, the server 350, the user 460, the gas utility 480, the compatible gas valve manufacture 490, the emergency service 495, or another third party. In another embodiment, the compatible gas valve 320, may comprise a compatible gas valve communication module 426 such as a cellular service provider module such as a 3G network module, a 4G network module, a 5G network module, a category M1 (CAT-M1) network module, a Long-Term Evolution (LTE) network module, a LTE-M network module, a cellular low-power side area network (cellular LPWAN), network module, a narrowband IoT (NB-IoT) network module, or category narrow band (CAT-NB) network module, a wireless fidelity (Wi-Fi) module such as a 2.4 GHz Wi-Fi module or a 5 GHz Wi-Fi module, or a near-field communication protocol module, such as a low-energy shortwave radio wave communication module, a small wave radio module, a long range low power radio (LoRa) module, LoRaWan module, a low power wide area network (LPWan) module, a radiofrequency (RF) communication module, a personal area network (PAN) module, such as a mesh network module, an infrared network module, a Bluetooth module, a ZigBee module, or a Z-wave module, a magnetic induction module, an optical transmission module, an acoustic wave module or other suitable system for communication between or simultaneously with components of the residential methane detection system 300, such as the RMD 330, the server 350, the user 460, the user's mobile device 472, the gas utility 480, the compatible gas valve manufacturer 490, the emergency service 495, or another third party. In another embodiment, the compatible gas valve 320 may be configured to be actuated remotely such as by the gas utility 480, such as by the gas utility cloud control panel dashboard server 482 or a gas utility technician remotely. In another embodiment, the compatible gas valve 320 may be configured to actuated locally or remotely such as by the compatible gas valve manufacturer 490, such as by a compatible gas valve manufacturer cloud server 492 or a compatible gas valve manufacturer technician. In another embodiment, the compatible gas valve 320 may be configured to be actuated locally or remotely such as by a user 460, such as by a user locally, a user remotely, a disabled user who is not able to leave the home in response to an alarm, or user who is a neighbor and does not have direct access to the property where the compatible gas valve 320 is located. The compatible gas valve 320, may however, be configured in any suitable manner to regulate, direct, control, stop or start the flow of the gas 310, and communicate with the internet of things, internet of things devices, or components of the residential methane detection system 300 or another third party.

In one embodiment, the residential methane detector (RMD) 330 may comprise a RMD gas sensor 432, a RMD power source 434, a RMD communication module 436, and optionally a RMD user interface. In one embodiment, the RMD gas sensor 432 may be configured as a methane (CH₄) gas sensor. In this embodiment, the RMD gas sensor 432 is preferably installed at a high location relative to the interior space in which it is intended to sense methane such as by non-limiting example, within one foot (12 inches) of a ceiling in order to properly detect the methane which is less dense than carbon dioxide. In this embodiment, the RMD gas sensor 432 is preferably installed in a low location relative to a height of the interior space in which the RMD gas sensor 432 is installed, such as by non-limiting example, at a height proximal a height of a standard electrical outlet to properly sense propane and/or butane which is more dense than carbon dioxide. In another embodiment, RMD gas sensor 432 may detect one or more of a propane (C₃H₈) gas and a butane (C₄H₁₀) gas. In other embodiments, RMD gas sensor 432 may be configured to detect one or more of a pentane such as C₅H₁₂and a hexane such as C₆H₁₄ when the RMD gas sensor 432 is installed at an appropriate height relative to an interior space in which the RMD gas sensor 432 is installed. In another embodiment, the RMD 330 may be optionally configured with one RMD gas sensor 432 or more than one RMD gas sensor 432. In another embodiment, the RMD 330 may be optionally configured with a mechanical sensor, such as a vibrational sensor or a tuning fork sensor, a chemical sensor, an infrared sensor, an optical sensor, a calorimetric sensor, a pyroelectric sensor, a pellistor sensor, a photoionization sensor, a semiconducting metal oxide sensor, an electrochemical sensor, another type of gas sensor, or a combination of sensors. In another embodiment, the RMD gas sensor 432 may be configured as an infrared non-dispersive Infrared (NDIR) gas sensors configured to detect a potential decrease in transmitted infrared light in proportion to gas concentration. In one embodiment, the RMD power source 434 may be configured as a power source from line-voltage, such as 120V or 240V or a battery, such as an internal backup battery. In another embodiment, the RMD power source 434 may be configured to utilize solar energy from outside a user's residence or from inside a user's residence such as by non-limiting example, from light bulbs that may comprise one or more light-emitting diodes (LEDs). In another embodiment the RMD power source 434 may be configured to provide power from environmental power generation or energy harvesting by collecting small amounts of energy from various, unconventional sources such as light, heat, vibrations, and radio waves occurring in close proximity to the RMD 330. In one embodiment, the RMD user interface may be configured as a notification panel such as an audible user interface, such as an audible alarm or message, or a visual user interface, such as a notification light or display panel. In another embodiment, the RMD 330 may be configured as a smart IoT RMD, such as connected to a local network, a remote network, or constantly connected to the cloud. In another embodiment, the RMD 330 may be configured with a RMD gas sensor 432 that does not require calibration. In another embodiment, the RMD 330 may be configured with a RMD gas sensor 432 that minimizes or eliminates false positives such as from cleaning products, hair products, or other volatile chemicals. In another embodiment, the RMD 330 may be configured to be installed high in location where a gas 310 may be present. In another embodiment, the RMD 330 may be configured with one or more pre-determined threshold limits related to pre-defined levels of the methane gas 410 or grades of leak, such as a lower explosive level (LEL). In one embodiment, the RMD communication module 436 may be optionally configured as a cellular module such as a 3G network module, a 4G network module, a 5G, CAT-M1, a LTE network module, a LTE-M network module, a cellular LPWAN network module, a NB-IoT network module, or a CAT-NB network module, a wireless fidelity (Wi-Fi) module such as a 2.4 GHz Wi-Fi module or a 5 GHz Wi-Fi module, or a near-field communication protocol module such as low-energy shortwave radio wave communication module, a small wave radio module, a long range low power radio (LoRa) module, a LoRaWan module, a LPWan module, a radiofrequency (RF) communication module, a personal area network (PAN) module, such as a mesh network module, an infrared network module, a Bluetooth module, a ZigBee module, or a Z-wave module, a magnetic induction module, an optical transmission module, an acoustic wave module or other suitable system for communication to between or simultaneously with components of the residential methane detection system 300, such as the RMD 330, the server 350, the user 460, the user's mobile device 472, the gas utility 480, the compatible gas valve manufacturer 490, emergency services 495, or another third party. The RMD 330, may however, be configured in any manner suitable to measure or detect the presences of a gas, alarm, notify, and communicate with the internet of things, internet of things devices, or components of the residential methane detection system 300 or another third party.

In one embodiment, the communication network 340 may be optionally configured as a cellular network 442, such as a 3G network module, a 4G network module, a 5G, CAT-M1, a LTE network module, a LTE-M network module, a cellular LPWAN network module a NB-IoT network module, or a CAT-NB network module, a wireless fidelity (Wi-Fi) network such as a 2.4 GHz Wi-Fi network or a 5 GHz Wi-Fi network, or a near-field communication protocol such as low-energy shortwave radio wave communication network, a small wave radio network, a long range low power radio (LoRa) network 444, LoRaWan network, a LPWan network, a radiofrequency (RF) communication network, an intranet network connection, a remote network connection, a cloud network connection, a local area network (LAN) network connection, a wide area network (WAN) network connection, a personal area network (PAN), such as a mesh network, an infrared network, a Bluetooth network, a ZigBee network, or a Z-wave network, a magnetic induction network, an optical transmission network, an acoustic wave network or other suitable system for communication to between or simultaneously with components of the residential methane detection system 300, such as the RMD 330, the server 350, the user 460, the user's mobile device 472, the gas utility 480, the compatible gas valve manufacturer 490, emergency services 495, or another third party. The communication network 340, may however, be configured in any manner suitable to provide communication related to the internet of things, internet of things devices, and the residential methane detection system 300.

In one embodiment, the server 350 may be optionally configured with an authentication server, such as a genius box (GB) authentication server 452, or a monitoring server, such as a GB monitoring cloud server 454. In some embodiments, it may be preferable for the GB authentication server 452 and/or the GB monitoring cloud server 454 to utilize a high level of encryption such as by non-limiting example, a level of encryption used in the banking and financial industries to prevent cyberthreats. In one embodiment, the authentication server may be configured to control how users of the residential methane detection system 300 access resources with centralized access and authentication policies, such as authentication as user authentication that is password based, multi-factor, certificate based, biometric based such as facial, fingerprint, speaker, eye scanner, token based, hardware, software, or other suitable user authentication method. In another embodiment, the authentication server may be configured to control how components of the residential methane detection system 300 access resources with centralized access and authentication policies, such as device authentication that may be code based such as a QR code or a bar code, hardware such as a hardware security module or trusted platform module, software such as certificate or trusted platform module, one-way, two-way, more than two-way, distributed, symmetric key, server based, or centralized or other suitable device authentication method. In one embodiment, the monitoring server may be configured to provide a centralized location for communication between components of the residential methane detection system 300, such as a compatible gas valve 320, a RMD 330, a user's mobile device 472, a gas utility cloud control panel dashboard server 482, or a compatible gas valve manufacture cloud server 492. In one embodiment, the server 350 may be configured to provide manual or automated workflows or tasks, such as automatically shutting off a compatible gas valve 320 in response to a gas 310 leak. In one embodiment, the server 350 may be configured to communicate with an existing system, such as a network system, a security system, a home security system, an automation system, a home automation system, a monitored back office, a city system, a municipality system, a utility system, or other existing system related to securing, controlling, or monitoring a property. The server 350, may however, be configured in any manner suitable to provide authentication, monitoring, hosting, facilitating communication between, or storing the geographical information of users, components, devices, or services related to the residential methane gas detection system 300.

In one embodiment, a user 460 may comprise a user's mobile device 472. In one embodiment, a user 460 may be configured as a resident 470, a property owner, a homeowner, a renter, a property manager, a neighbor, a security system agency, a security system installer, a home automation agency, an automation integrator, an RMD technician, an RMD installer, a RMD distributor, a gas utility personnel, a compatible gas valve manufacture personnel, an emergency service personnel, any person with a mobile device connected to the residential methane detection system 300, or any person who dwells on or near a property. In one embodiment, the property, may be configured as residential property, such as a single-family home, a private residence, an apartment complex, a condominium complex, a townhome complex, or a multifamily complex, a commercial property, such as an office, a retail, a warehouse, a storage property, or a mixed-use property, or a mobile property such as a manufactured home, a recreational vehicle, a trailer, a camper; a van; a utility vehicle, a commercial utility vehicle, a gas service vehicle, another mobile vehicle, or any suitable location that facilitates the supply or storage of the gas or use of the gas by an appliance. The user 460, may however, be configured in any manner suitable to authenticate, install, communicate, control, receive notifications, set preferences and limits, or otherwise interface with the RMD 330 or components of the residential methane detection system 300.

In one embodiment, a user's mobile device 472 may comprise a mobile device application. In another embodiment, a user's mobile device 472 may be configured in the form factor of a computing device such as a phone, a tablet, a handheld mobile device, a portable mobile device, or a laptop, an integrated panel such as a security panel, a wall mounted panel, a base station; a home security panel, an automation panel, or a user interface panel, a connected vehicle, a connected wearable device such as a piece of jewelry, a watch, a band, a card, a key, a key ring, a tag, an item of clothing, or suitable mobile device for communicating with other devices and displaying messages, providing an interface for a mobile device user, facilitating communication between components of the residential methane detection system 300, such as the RMD 330, the communication network 340, the server 350, or other wireless networks. In another embodiment, the mobile device 472 may comprise additional elements such as an antenna, a processor, a power source, such as a battery, a memory, an audio component such as a microphone and a speaker, or a physical connector such as a universal serial bus (USB). The user's mobile device 472, may however, be configured in any suitable matter to facilitate the authentication, setup, communication, display of notifications or information, and user interface including user preference setting related to the RMD 330, to notify a property's occupants by the mobile application not to return home until it is safe to do so, or communicate with the components residential methane detection system 300.

A residential methane detection system 300 according to various aspects of an embodiment of the invention provides for cloud connected methane leak monitoring, alarm, and notification and automatic gas valve shutoff in response to a methane leak connection as shown in FIGS. 1A-1C.

In another embodiment, the RMD 330 may be configured to determine if the battery life of the RMD 330, such as an internal battery or a connected backup battery, has a battery life less than a predetermined threshold, such as less than about 75% of a predetermined battery life, then the RMD 330 will alert the user 460, such as by a battery alarm notification as shown in FIGS. 1A-1C. In another embodiment, the RMD 330 may be configured to determine that if the battery life of the RMD 330 is more than a predetermined threshold, such as more than or equal to about 75% of a predetermined battery life then the RMD 330 may start a cloud connection as shown in FIGS. 1A-1C.

In one embodiment, the RMD 330 may be configured to start a cloud connection such as a communication network 340, such as a cellular network 442, a LoRa network 444, or both as shown in FIGS. 1A-1C.

In another embodiment, the RMD 330 may be configured to determine that if a cellular network 442 is not found then the RMD 330 will alert the user 460, such as by a communication error alarm notification, such as by a notification on the RMD 330 or other type of connected notification as shown in FIGS. 1A-1C. In another embodiment, the RMD 330 may be configured to determine that if a communication network 340, such as a cellular network 442, is found then the RMD 330 will activate a communication network 340 such as a cellular connection and Bluetooth connection. In another embodiment, the RMD 330 may be configured that once a communication network 340, such as a cellular network 442, is found then the RMD 330 will search for a user's mobile device 472 and mobile application, such as an iOS or android application and if the mobile application is found then the RMD 330 will request/require authentication password from the mobile application, such as authentication through the server 350, such as the GB authentication server 452. In another embodiment, the RMD 330 may be configured that if the mobile application or RMD password is not authenticated then the RMD 330 will alert the user 460, such as by a log in or password alarm notification as shown in FIGS. 1A-1C. In another embodiment, the RMD 330 may be configured that if the mobile application or RMD password is authenticated then the RMD 330 will connect to the user's mobile device 472 and the RMD will perform a handshake with the server 350, such as the GB monitoring with cloud server 454 as shown in FIGS. 1A-1C.

In another embodiment, the RMD 330 may be configured to determine that if a communication network 340, such as a LoRa network 444, is not found then the RMD 330 will alert the user, such as on a panel on the RMD 330, a LoRa alarm notification, or other notification as shown in FIGS. 1A-1C. In another embodiment, the RMD 330 may be configured to determine that a communication network 340, such as a LoRa network 444, is found then the RMD 330 will communicate with the server 350, such as an authentication server, such as a genius box (GB) authentication server 452.

In one embodiment, the server 350, such as an authentication server, such as a genius box (GB) authentication server 452, may be configured to block a connection with a RMD 330 that is not authenticated. In one embodiment, the server 350, such as an authentication server, such as a genius box (GB) authentication server 452, may be configured to perform a handshake with another server 350, such as a monitoring server, such as GB monitoring with cloud server 454 and an RMD 330 that is authenticated as shown in FIGS. 1A-1C.

In another embodiment, the RMD 330 may be configured that if the RMD 330 on the communication network 340, such as the LoRa network 444, is authenticated then the RMD 330 may check for, download, and install applicable firmware updates related to the RMD 330 as shown in FIGS. 1A-1C.

In another embodiment, the server 350, such as an authentication server, such as a genius box (GB) authentication server 452, may be configured to search for, establish a connection with, and communicate with a compatible gas valve 320 as shown in FIGS. 1A-1C. In another embodiment, the server 350, such as an authentication server, such as a genius box (GB) authentication server 452, may be configured to notify the gas valve manufacture 490, such as by a gas valve manufacturer cloud server dashboard 492, or notify the gas utility 480, such as by the gas utility cloud control panel dashboard server 482, that a compatible gas valve 320 has been connected as shown in FIGS. 1A-1C.

In another embodiment, the server 350, such as an authentication server, such as a genius box (GB) authentication server 452, or a monitoring server, such as a GB monitoring with cloud server 454, may be configured to authenticate the gas utility 480, such as by a gas utility password by a gas utility cloud control panel dashboard server 482. In another embodiment, the server 350, may be configured that if the gas utility 480 has not been authenticated then the server 350 may block the gas utility's 480 access to an associated RMD 330. In another embodiment, the server 350, may be configured that if the gas utility 480 has been authenticated and is logged in with a valid password then the server 350 may grant the gas utility 480 access to the real time gas monitoring of an associated RMD 330, such as by a gas utility cloud control panel dashboard server 482 as shown in FIGS. 1A-1C.

In another embodiment, the server 350, such as a monitoring server, such as a GB monitoring with cloud server 454, may be configured to start real time monitoring by setting the RMD 330 to a mode, such as a live mode or sending a power on command to the RMD 330. In another embodiment, the server 350, such as a monitoring server, such as a GB monitoring with cloud server 454, may be configured that once the gas utility 480 has been authenticated and real time monitoring of an RMD 330 has been started, then the server 350 may notify the gas utility 480 of the RMD 330's location and any associated compatible gas valve's 320, and associated information, such as number of RMD's 330, number of compatible gas valves 330, user information, such as the user 460, the resident 470, or the user's mobile device 472, or property information, such as where the RMD is installed, or a visual map and physical address of the RMD's 330 installed location as shown in FIGS. 1A-1C.

In another embodiment, the server 350, such as a monitoring server, such as a GB monitoring with cloud server 454, may be configured to check if the RMD 330 is powered on, connect, or in an expected mode, such as the live mode such as by checking the RMD 330 at about constant time intervals as shown in FIG. 1. In another embodiment, the server 350, may be configured that if the RMD 330 is not in the live mode, the server 350 may notify the user with an alarm, set the RMD 330 to live mode, or communicate with the gas utility 480 by the cloud control panel dashboard server 482 as shown in FIGS. 1A-1C.

In another embodiment, the server 350, may be configured that if the RMD 330 is in the live mode, then the server 350 may query the RMD 330 for information about a gas leak 310 as shown in FIGS. 1A-1C. In another embodiment, the server 350, may be configured that if the RMD 330 communicates a gas 310 measurement that is not greater than or equal to about a preset LEL levels, such as a low a2 explosive level, then the server 350 may continue to check that the RMD 330 is in the live mode such as by checking that the RMD 330 is powered on and connected at about constant time intervals. In another embodiment, the server 350, may be configured that if the RMD 330 communicates a gas 310 measurement that is greater than or equal to about a preset LEL level, such as a LEL about less than 10%, about 10%, about 10% to about 25%, about 25%, or about a low a2 explosive level, then the server 350 may notify the gas utility 380, such as by the gas utility cloud control panel dashboard server 482 of a potential leak, the user 460, such as by the user's mobile device 472, with an alarm such as a warning to have all occupants vacate the premises, or optionally the gas valve manufacture 480 or emergency services 495. In some embodiments, the preset LEL level may be adjusted by the manufacturer or remotely via the server 350 to meet local compliance legislation regarding gas detection levels. In another embodiment, the server 350, may be configured that if the RMD 330 communicates a gas 310 measurement that is greater than or equal to about a preset LEL level, the RMD 330 may alarm, such as an audible alarm, such as a loud audio alarm or a spoken alarm, a tactile alarm, such as a vibration, or a visual alarm, such as a displayed message or an indicator light as shown in FIGS. 1A-1C. In another embodiment, the RMD 330, the server 350, or the user's mobile device 472, may be configured to communicate information about the urgency of a gas 310 leak such as warning if the gas 310 leak is slow, an alarm if the gas 310 leak is fast, or a shutdown notification if the compatible gas valve 320 has been shut down, such as due to a potential threat of explosion.

In another embodiment, the server 350, may be configured that if the RMD 330 communicates a gas 310 measurement that is greater than or equal to about a preset LEL level and the leak rate presents a potentially imminent possible explosion event, then the RMD 330 or the server 350 may trigger the compatible gas valve 320 to shut down or close and optionally notify the compatible gas valve manufacture 490, such as by the compatible gas valve manufacture cloud server 492, the gas utility 480, such as by the gas utility cloud control panel dashboard server 482, the user 460, the resident 470, the emergency services 495, or another third party and may include information about the urgency of the gas 310 leak, RMD 330, and RMD's 330 installed location, such as a physical property address as shown in FIGS. 1A-1C. In another embodiment, the server 350, may be configured that if the RMD 330 communicates a potentially imminent possible explosion event the RMD 330 may alarm, such as an audible alarm, such as a loud audio alarm or a spoken alarm, a tactile alarm, such as a vibration, or a visual alarm, such as a displayed message or an indicator light as shown in FIG. 1. In another embodiment, the gas utility 480, the compatible gas valve manufacture 490, or another third party may be configured to notify the emergency services 495 of a gas 310 leak. In another embodiment, the gas utility 480, the compatible gas valve manufacture 490, or another third party may remotely actuate the compatible gas valve 320 to restore gas flow after a problematic gas leak has been detected and repaired.

In one embodiment, the compatible gas valve 320, the RMD 330, the user's mobile device 472, or the server 350, may be configured to establish and maintain user 460 preferences related to the residential methane detection system 300. In one embodiment, the user's mobile device 472, may be configured to query a user 460 to determine if the user 460 is outside the property where the RMD 330 is installed as shown in FIG. 1. In one embodiment, the user's mobile device 472, may be configured that if the user 460 is outside the home to ask the user 460 if the user 460 wants to monitor the surrounding RMD's 330 for a gas 310 leak. In one embodiment, the server 350 or the user's mobile device 472, may be configured to determine the physical location of a user's mobile device 472, such as by global positioning satellite system (GPS) and determine if any RMD's 330 are present, nearby, or within a predetermined proximity to the user's mobile device 472, such as if a nearby property has an installed RMD 330 that that is monitoring for a gas 310 leak and the user 460, such as a neighbor or a responding technician or emergency service 495, would benefit from a notification that the neighbor's RMD 330 has detected a gas 310 leak at about or above a predetermined threshold such as an potentially imminent possible explosion event as shown in FIGS. 1A-1C.

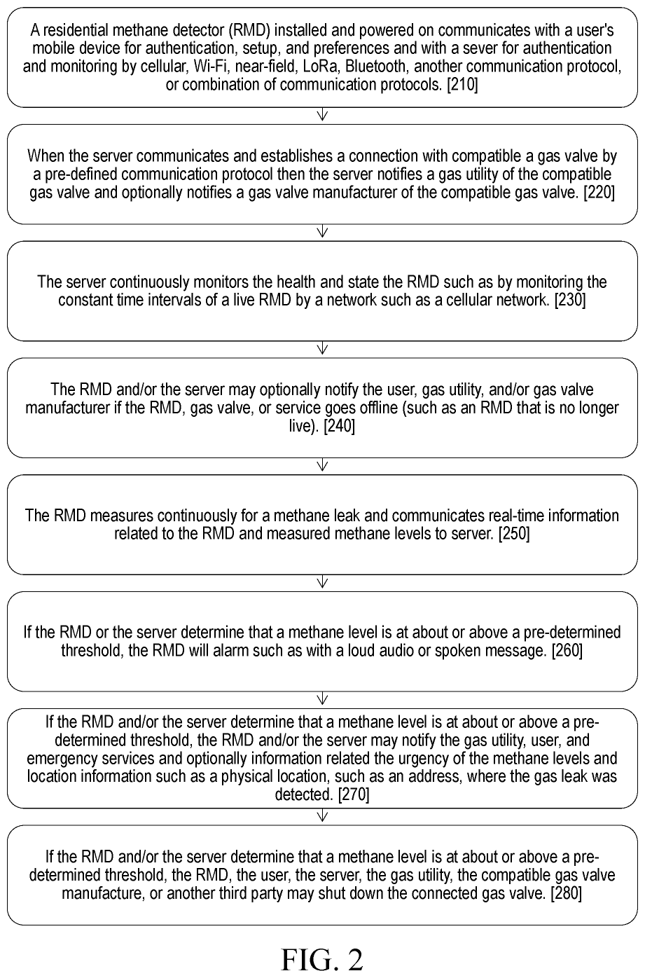

In one application, a residential methane detection system 300 may detect or measure the presence of a gas, such as a methane gas, with a residential methane detector (RMD) that when installed and powered on communicates with a user's mobile device for authentication, setup, and preferences and with a sever for authentication and monitoring by cellular, Wi-Fi, near-field, LoRa, Bluetooth, another communication protocol, or combination of communication protocols 210, and when the server communicates and establishes a connection with compatible a gas valve by a pre-defined communication protocol then the server notifies a gas utility of the compatible gas valve and optionally notifies a gas valve manufacturer of the compatible gas valve 220 as shown in FIG. 2. In one embodiment, the residential methane detection system may provide for the server to continuously monitor the health and state the RMD such as by monitoring the constant time intervals of a live RMD by a network such as a cellular network 230 as shown in FIG. 2. In another embodiment, the residential methane detection system may provide for the RMD or the server to optionally notify the user, gas utility, or gas valve manufacturer if the RMD, gas valve, or service goes offline (such as an RMD that is no longer live) 240 as shown in FIG. 2.

In one embodiment, the residential methane detection system 300 may provide for the RMD to measure continuously for a methane leak and communicate real-time information related to the RMD and measured methane levels to the server 250, and if the RMD or the server determine that a methane level is at about or above a pre-determined threshold, the RMD will alarm such as with a loud audio or spoken message 260 as shown in FIG. 2.

In one embodiment, the residential methane detection system may provide for either the RMD or the server or both to determine that a methane level is at about or above a pre-determined threshold and for either the RMD or the server to notify the gas utility, user, and emergency services and optionally information related the urgency of the methane levels and location information such as a physical location, such as an address, where the gas leak was detected 270 as shown in FIG. 2.

In one embodiment, the residential methane detection system 300 may provide for either the RMD or the server or both to determine that a methane level is at about or above a pre-determined threshold then components of the residential methane detection system, such as the RMD, the user, the server, the gas utility, the compatible gas valve manufacture, or another third party may shut down, such as close off, the connected compatible gas valve 280 as shown in FIG. 2.

In one application, the residential methane detection system 300 may be configured with more than one component, such as more than one RMD 330 or more than one compatible gas valve 320 at or near the same physical location, such as an apartment complex or office complex or multiple RMD's 330 place close to each appliance's location within a physical location, such as one by a stove and one by a water heater. In one embodiment, the residential methane detection system 300 may be configured with more than one component, such as more than one RMD 330 or more than one compatible gas valve 320 at or near the different physical locations, such as a primary residence and a secondary residence.

In one embodiment, the residential methane detection system 300 may be configured with components that are associated with a single user's 460 account or multiple user's 460 accounts either at the same or different physical addresses.

In another embodiment, the residential methane detection system 300 may be configured with the RMD 330 and the compatible gas valve 320 in a relationship that is one-to-one, one-to many, many-to-one, or many-to-many.

In places where the description above refers to particular implementations of systems and methods for residential methane detection, it should be readily apparent that a number of modifications may be made without departing from the spirit thereof and that these implementations may be applied to other to systems and methods for residential methane detection.

I/We claim:

1. A gas detection system, comprising;
a gas valve configured for remote actuation;
a gas valve communication module configured to communicate with at least one of an authentication server and a monitoring server over a communication network;
a gas detector comprising:
a gas sensor configured to detect a level of a gas that exceeds a predetermined threshold level;
a gas detector power source;
a gas detector user interface; and
a gas detector communication module configured to communicate with the at least one of the authentication server and the monitoring server over the communication network in response to detection by the gas sensor of the predetermined threshold level of the gas being exceeded;
wherein the gas valve is configured to be remotely actuated to a closed position in response to a signal received by the gas valve communication module from at least one of the authentication server and the monitoring server in response to a prior communication from the gas valve communication module that the predetermined threshold level of the gas is exceeded.

2. The gas detection system of claim 1, wherein the gas valve comprises at least one of a gas pipe shutoff, a solenoid, a servomotor, a check valve, a control valve, a hydraulic valve, a pneumatic valve, an electric valve, a thermal valve, a magnetic valve, a mechanical valve, a single valve, a single port valve, a multiple port valve, and a flow regulator valve.

3. The gas detection system of claim 1, wherein the communication network comprises at least one of the following: a cellular network, a 3G cellular network, a 4G cellular network, a 5G cellular network, a LTE cellular network, a LTE-M cellular network, a low power wide area network cellular network (cellular LPWAN), a category M1 (CAT M1) cellular network, a narrowband IoT (NB-IoT) network, a category narrow band (CAT-NB) network, a wireless fidelity (Wi-Fi) network, a 2.4 GHz Wi-Fi network, a 5 GHz Wi-Fi network, a near-field communication protocol, a low-energy shortwave radio wave communication network, a small wave radio network, a long range low power radio (LoRa) network, LoRaWan network, a low power wide area network (LPWan) network, radiofrequency (RF) communication network, an intranet network connection, a remote network connection, a cloud network connection, a local area network (LAN) network connection, a wide area network (WAN) network connection, a personal area network (PAN), a mesh network, an infrared network, a Bluetooth network, a ZigBee network, a Z-wave network, a magnetic induction network, an optical transmission network, and an acoustic wave network.

4. The gas detection system of claim 1, wherein the authentication server comprises at least one of a centralized access and authentication policy based server, a user authentication server, a password based authentication server, a multi-factor authentication server, a certificate based authentication server, a biometric authentication server, a facial authentication server, a fingerprint authentication server, a speaker authentication server, an eye scanner authentication server, a token based authentication server, a hardware authentication server, a software authentication server, a device authentication server, a QR code authentication server, a bar code authentication server, a hardware security module authentication server, a trusted platform module authentication server, a certificate authentication server, a distributed authentication server, a symmetric key authentication server, a server based authentication server, and a centralized authentication server method.

5. The gas detection system of claim 1, wherein the monitoring server comprises at least one of a monitoring cloud server, a centralized monitoring server, and a dashboard server.

6. The gas detection system of claim 1, wherein the gas detector user interface is configured to provide a notification, wherein the notification comprises at least one of a notification interface, an audible user interface, an audible alarm, a message, an audible message, a visual user interface, a visual message, a notification light, a display panel, a warning, an alert, and an offline message.

7. The gas detection system of claim 1, wherein the gas valve is configured to be actuated by at least one of a command proximal to the area where the potential gas leak was detected, a command remote to the area where the potential gas leak was detected, a server command, a gas detector command, a user command, a user's mobile device command, a gas utility command, a compatible gas valve manufacture command, and a third-party command.

8. The gas detection system of claim 1, wherein the gas comprises at least one of a methane gas, a methane gas mixture containing additives, a butane, a propane, and a hydrocarbon gas mixture.

9. The gas detection system of claim 1, wherein the gas sensor comprises at least one of a single gas sensor, multiple gas sensors, a mechanical sensor, a vibrational sensor, a tuning fork sensor, a chemical senso, an infrared sensor, a non-dispersive infrared (NDIR) gas sensor, an optical sensor, a calorimetric sensor, a pyroelectric sensor, a pellistor sensor, a photoionization sensor, a semiconducting metal oxide sensor, an electrochemical sensor, a methane gas sensor, an uncalibrated gas sensor, a partially calibrated gas sensor, and a calibrated gas sensor.

10. The gas detection system of claim 1, further configured to notify a user when the gas sensor detects that the level of gas exceeds the predetermined threshold level via at least one of a visual notification, an audible notification, an alert, a warning, a lower explosive level (LEL), a percentage level, a discrete level, a message, and a message to vacate.

11. A method of gas detection comprising;
detecting, by a gas sensor of a gas detector, a presence of a gas that exceeds a predetermined threshold level of the gas;
sending, by a communication module of the gas detector and via a communication network, a communication to at least one of an authentication server and a monitoring server in response to detecting the presence of the gas that exceeds the predetermined threshold level of the gas, the gas detector further comprising a gas detector power source and a gas detector user interface;
receiving, by a communication module of a gas valve that is configured for remote actuation, a signal from the at least one of the authentication server and the monitoring server via the communication network in response to the prior communication to the at least one of the authentication server and the monitoring server; and
remotely actuating the gas valve to a closed position in response to the signal received by the communication module of the gas detector.

12. The method of gas detection of claim 11, wherein the gas valve comprises at least one of a gas pipe shutoff, a solenoid, a servomotor, a check valve, a control valve, a hydraulic valve, a pneumatic valve, an electric valve, a thermal valve, a magnetic valve, a mechanical valve, a single valve, a single port valve, a multiple port valve, and a flow regulator valve.

13. The method of gas detection of claim 11, wherein the communication network comprises at least one of the following: a cellular network, a 3G cellular network, a 4G cellular network, a 5G cellular network, a LTE cellular network, a LTE-M cellular network, a low power wide area network cellular network (cellular LPWAN), a category M1 (CAT M1) cellular network, a narrowband IoT (NB-IoT) network, a category narrow band (CAT-NB) network, a wireless fidelity (Wi-Fi) network, a 2.4 GHz Wi-Fi network, a 5 GHz Wi-Fi network, a near-field communication protocol, a low-energy shortwave radio wave communication network, a small wave radio network, a long range low power radio (LoRa) network, LoRaWan network, a low power wide area network (LPWan) network, radiofrequency (RF) communication network, an intranet network connection, a remote network connection, a cloud network connection, a local area network (LAN) network connection, a wide area network (WAN) network connection, a personal area network (PAN), a mesh network, an infrared network, a Bluetooth network, a ZigBee network, a Z-wave network, a magnetic induction network, an optical transmission network, and an acoustic wave network.

14. The method of gas detection of claim 11, wherein the authentication server comprises at least one of a centralized access and authentication policy based server, a user authentication server, a password based authentication server, a multi-factor authentication server, a certificate based authentication server, a biometric authentication server, a facial authentication server, a fingerprint authentication server, a speaker authentication server, an eye scanner authentication server, a token based authentication server, a hardware authentication server, a software authentication server, a device authentication server, a QR code authentication server, a bar code authentication server, a hardware security module authentication server, a trusted platform module authentication server, a certificate authentication server, a distributed authentication server, a symmetric key authentication server, a server based authentication server, and a centralized authentication server method.

15. The method of gas detection of claim 11, wherein the monitoring server comprises at least one of a monitoring cloud server, a centralized monitoring server, and a dashboard server.

16. The method of gas detection of claim 11, further comprising providing, by the gas detector user interface, a notification, wherein the notification comprises at least one of a notification interface, an audible user interface, an audible alarm, a message, an audible message, a visual user interface, a visual message, a notification light, a display panel, a warning, an alert, and an offline message.

17. The method of gas detection of claim 11, wherein the gas valve is configured to be actuated by at least one of a command proximal to the area where the potential gas leak was detected, a command remote to the area where the potential gas leak was detected, a server command, a gas detector command, a user command, a user's mobile device command, a gas utility command, a compatible gas valve manufacture command, and a third-party command.

18. The method of gas detection of claim 11, wherein the gas comprises at least one of a methane gas, a methane gas mixture containing additives, a butane, a propane, and a hydrocarbon gas mixture.

19. The method of gas detection of claim 11, wherein the gas sensor comprises at least one of a single gas sensor, multiple gas sensors, a mechanical sensor, a vibrational sensor, a tuning fork sensor, a chemical sensor, an infrared sensor, a non-dispersive infrared (NDIR) gas sensor, an optical sensor, a calorimetric sensor, a pyroelectric sensor, a pellistor sensor, a photoionization sensor, a semiconducting metal oxide sensor, an electrochemical sensor, a methane gas sensor, an uncalibrated gas sensor, a partially calibrated gas sensor, and a calibrated gas sensor.

20. The method of gas detection of claim 11, further comprising notifying a user when the gas sensor detects that the level of gas exceeds the predetermined threshold level via at least one of a visual notification, an audible notification, an alert, a warning, a lower explosive level (LEL), a percentage level, a discrete level, a message, and a message to vacate.
